(19) United States
(12) Patent Application Publication
(10) Pub. No.: US 2013/0150023 A1
(43) Pub. Date: Jun. 13, 2013

(54) HANDOVER CONTROLLING METHOD, OPERATING METHOD OF WIRELESS COMMUNICATION TERMINAL, AND STATION

(71) Applicants: Hong Soog KIM, Daejeon (KR); Byung-Han RYU, Daejeon (KR); Nam Hoon PARK, Daejeon (KR)

(72) Inventors: Hong Soog KIM, Daejeon (KR); Byung-Han RYU, Daejeon (KR); Nam Hoon PARK, Daejeon (KR)

(73) Assignee: Electronics and Telecommunications Research Institute, Daejeon (KR)

(21) Appl. No.: 13/609,827

(22) Filed: Sep. 11, 2012

(30) Foreign Application Priority Data
Dec. 9, 2011 (KR) 10-2011-0132076

(51) Int. Cl. H04W 36/32; H04W 24/00

(52) U.S. Cl. 455/423; 455/440

(57) ABSTRACT

Disclosed is a handover controlling method in which a station controls a handover of user equipment. The handover controlling method includes receiving a handover request including location information from the user equipment; and comparing the location information with handover histories previously executed at the station to control a handover of the user equipment according to a comparison result.

### CROSS-REFERENCE TO RELATED APPLICATIONS

A claim for priority under 35 U.S.C. §119 is made to Korean Patent Application No. 10-2011-0132076 filed Dec. 9, 2011, in the Korean Intellectual Property Office, the entire contents of which are hereby incorporated by reference.

### BACKGROUND

The inventive concepts described herein relate to wireless communication, and more particularly, relate to a handover controlling method, an operating method of a wireless communication terminal, and a station.

A wireless mobile network may provide a seamless wireless communication service to a wireless communication terminal having mobility. The wireless mobile network may be formed of a plurality of stations.

Each station may operate one or more cells. A station may perform wireless communication with a wireless communication terminal placed within a corresponding cell. When a wireless communication terminal moves from one cell (e.g., a source cell) into another cell (e.g., a target cell), a station of the target cell may establish communication with a wireless communication terminal, and a station of the source cell may terminate communication with the wireless communication terminal. This operation may be referred to as a handover (HO). The handover may enable the wireless mobile network to provide a seamless wireless communication service to a wireless communication terminal.

Commercialized wireless mobile networks may include GSM (Global System for Mobile communication), CDMA (Code Division Multiple Access), WCDMA (Wideband CDMA), CDMA 2000, WiMAX (World interoperability for Microwave Access), LTE (Long Term Evolution), and the like.

### SUMMARY

Example embodiments of the inventive concept provide a handover controlling method in which a station controls a handover of a user equipment, the handover controlling method comprising receiving a handover request including location information from the user equipment; and comparing the location information with handover histories previously executed at the station to control a handover of the user equipment according to a comparison result.

In example embodiments, the comparing the location information with handover histories previously executed at the station to control a handover the user equipment according to a comparison result comprises controlling a handover of the user equipment according to a handover history, executed within a reference distance from a location corresponding to the location information, among from the previously executed handover histories.

In example embodiments, the controlling a handover of the user equipment according to a handover history comprises controlling a handover of the user equipment the same as the handover history being a successful handover.

In example embodiments, the controlling a handover of the user equipment according to a handover history comprises terminating a handover of the user equipment when the handover history is a too early handover.

In example embodiments, the controlling a handover of the user equipment according to a handover history comprises controlling a handover of the user equipment to be faster than the handover history when the handover history is a too late handover.

In example embodiments, the controlling a handover of the user equipment according to a handover history comprises controlling a handover of the user equipment to a final cell indicated by the handover history when the handover history is a handover to a wrong cell.

In example embodiments, the handover controlling method further comprises receiving a handover history report from the user equipment; judging whether the handover history is a successful handover, a too early handover, a too late handover, or a handover to a wrong cell; and storing the judgment result with the handover history.

In example embodiments, the handover history is judged to be the successful handover when the handover history indicates a handover executed without radio link failure.

In example embodiments, the handover history is judged to be the too late handover when the handover history indicates that radio link failure is generated before completion of a handover and then radio resource control connection are reestablished with a target station.

In example embodiments, the handover history is judged to be the too early handover when the handover history indicates that radio link failure is generated when a handover is completed and the user equipment moves below a reference distance and then radio resource control connection are reestablished with a source station.

In example embodiments, the handover history is judged to be the too early handover when the handover history indicates that radio link failure is generated when a handover is completed and the user equipment moves below a reference distance and then radio resource control connection are reestablished with a final station not a source station or a target station.

In example embodiments, the storing the judgment result with the handover history comprises searching a handover history, indicating a successful handover, from among previously stored handover histories when the handover history is the too early handover or the handover to a wrong cell, the searched handover history having the same source cell, target cell, measurement report location, radio resource control reconfiguration location, and radio resource control reconfiguration complete location as the handover history; and deleting the searched handover history.

Example embodiments of the inventive concept also provide an operating method of a wireless communication terminal which comprises storing location information of the wireless communication terminal when sending a handover request; storing location information of the wireless communication terminal when a handover corresponding to the handover request is completed; when radio link failure is generated before the handover, during execution of the handover, or after completion of the handover, sending a radio resource control connection reestablishment request and storing location information of the wireless communication terminal; and sending the stored location information.

In example embodiments, the handover request is sent with the location information.

In example embodiments, the operating method further comprises storing location information of the wireless communication terminal when the handover commences.

In example embodiments, the operating method further comprises storing location information of the wireless communication terminal when radio resource control reestablishment is completed.

In example embodiments, the operating method further comprises storing information associated with a communicating cell before the handover, a target cell of the handover when the handover commences, and a finally communicating cell after the handover or the radio link failure.

In example embodiments, the information on the stored cells and the stored location information are sent to the finally communicating cell.

Example embodiments of the inventive concept also provide a station which comprises a communication unit performing wireless communication with a wireless communication terminal; a handover control database storing handover histories previously executed within a charging cell; and a processing unit operating a protocol communicating an upper server and controlling a handover of the wireless communication terminal based on the handover histories stored at the handover control database.

In example embodiments, the handover control database stores the handover histories classified into a successful handover, a too later handover, a too early handover, and a handover to a wrong cell.

### BRIEF DESCRIPTION OF THE FIGURES

The above and other objects and features will become apparent from the following description with reference to the following figures, wherein like reference numerals refer to like parts throughout the various figures unless otherwise specified, and wherein

FIG. 1 is a diagram illustrating a wireless communication network according to an embodiment of the inventive concept.

FIG. 2 is a block diagram schematically illustrating a station in FIG. 1.

FIG. 3 is a table illustrating handover histories stored at and managed by a handover control database in FIG. 2.

FIG. 4 is a table illustrating handover parameters stored and managed at a handover parameter database in FIG. 2.

FIG. 5 is a diagram illustrating a location movement of the user equipment UE when the UE performs a successful handover from a source cell to a target cell.

FIG. 6 is a diagram illustrating a procedure when the UE performs a successful handover from a source cell to a target cell.

FIG. 7 is a diagram illustrating a location movement of the UE when the UE performs a too late handover from a source cell to a target cell.

FIG. 8 is a diagram illustrating a procedure when the UE performs a too late handover from a source cell to a target cell.

FIG. 9 is a diagram illustrating a location movement of the UE when the UE performs a too early handover from a source cell to a target cell.

FIG. 10 is a diagram illustrating a procedure when the UE performs a too early handover from a source cell to a target cell.

FIG. 11 is a diagram illustrating a location movement of the UE when the UE performs a handover to a wrong cell.

FIG. 12 is a diagram illustrating a procedure when the UE performs a handover to a wrong cell.

FIG. 13 is a flowchart illustrating a method of storing a handover history at a handover control database through a station.

FIG. 14 is a flowchart illustrating a method of controlling a handover of the UE according to a handover history.

### DETAILED DESCRIPTION

Embodiments will be described in detail with reference to the accompanying drawings. The inventive concept, however, may be embodied in various different forms, and should not be construed as being limited only to the illustrated embodiments. Rather, these embodiments are provided as examples so that this disclosure will be thorough and complete, and will fully convey the concept of the inventive concept to those skilled in the art. Accordingly, known processes, elements, and techniques are not described with respect to some of the embodiments of the inventive concept. Unless otherwise noted, like reference numerals denote like elements throughout the attached drawings and written description, and thus descriptions will not be repeated. In the drawings, the sizes and relative sizes of layers and regions may be exaggerated for clarity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another region, layer or section.

Thus, a first element, component, region, layer or section discussed below could be termed a second element, component, region, layer or section without departing from the teachings of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Also, the term “exemplary” is intended to refer to an example or illustration.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

A term “user equipment’ is used for indicating a wireless communication terminal used by an end-user. The term “user equipment” can be interchanged with terms “wireless communication terminal”, “access terminal”, “mobile station”, etc.

A term “source cell” indicates a cell in which a user equipment communicates before a handover. A term “source station” indicates a station managing the source cell. A term “target cell” indicates a cell which is dedicated to a target of a handover. A term “target station” indicates a station managing the target cell. A term “final cell” indicates a cell where a user equipment communicates after a completion of a handover. A term “final station” indicates a station managing the final station. The terms “source cell”, “target cell” and “final cell” can be used interchangeably with the terms “source station”, “target station” and “final station” respectively. The terms used herein may be interpreted as “cell” or “station” according to associated contexts.

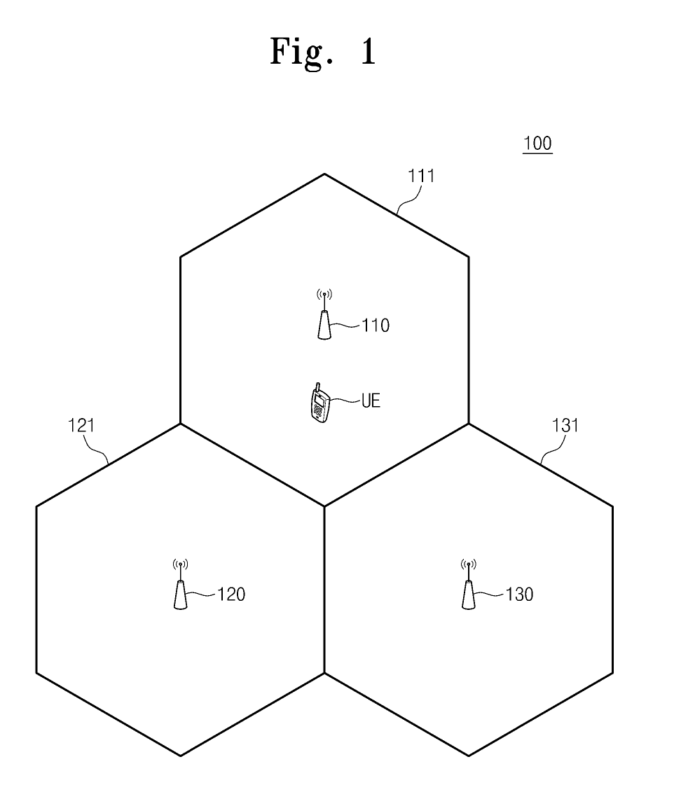

FIG. 1 is a diagram illustrating a wireless communication network according to an embodiment of the inventive concept. Referring to FIG. 1, a wireless communication network 100 may include stations 110, 120, and 130.

The stations 110, 120, and 130 may conduct wireless transmission and reception with user equipment UE. The stations 110, 120, and 130 may form cells 111, 121, and 131, respectively. The UE may include wireless communication terminals such as a cellular phone, a smart phone, a netbook, a PDA, a tablet, a smart tablet, and the like.

When the UE moves from the cell 111 to the cell 121, a handover may occur between the stations 110 and 120 to establish communication with the UE. For example, the UE may send a handover request to the station 110 according to strengths of signals received from the stations 110 and 120. The station 110 may transfer the handover request to the station 120. If the station 120 establishes communication with the UE, the UE may terminate communication with the station 110. That is, if a handover is performed, a station managing communication with the UE may be switched into the station 120 from the station 110.

An error may arise due to various factors when a handover is performed. For example, there may be generated a too early handover that a handover of the UE is too early performed. In this case, a signal of the target station may become weak, so that the UE experiences radio link failure (RLF). Thus, the radio link failure (RLF) may occur after a handover.

There may be generated a too late handover that a handover of the UE is too late performed. In this case, a signal of the source station may become weak, so that the UE experiences radio link failure (RLF). Thus, the radio link failure (RLF) may occur before a handover.

As another example, a handover to a wrong cell can be generated. In this case, the UE experiences radio link failure (RLF) until a handover to a right cell is performed. A wrong handover to a wrong target cell may appear. Then, a handover to a final cell may appear.

As described above, the UE may experience radio link failure (RLF) due to various factors at a handover. To overcome this drawback, the inventive concept may be configured to collect location information associated with a handover of the UE and handover histories and to control the handover of the UE based on the collected result.

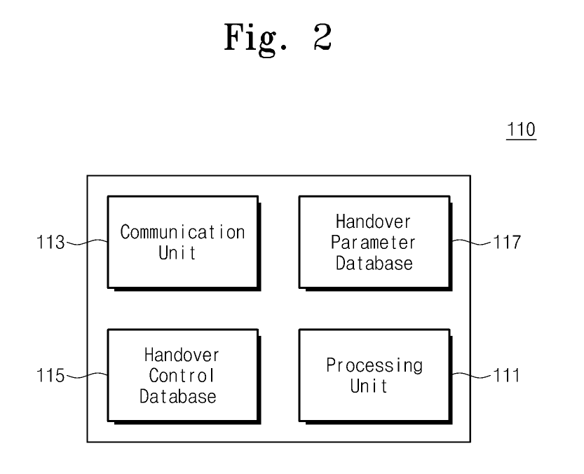

FIG. 2 is a block diagram schematically illustrating a station in FIG. 1. One station 110 is exemplarily illustrated in FIG. 2, but the remaining stations 120 and 130 may be configured substantially the same as that in FIG. 2.

Referring to FIGS. 1 and 2, a station 110 may include a processing unit 111, a communication unit 113, a handover control database 115, and a handover parameter database 117.

The processing unit 111 may control an overall operation of the station 110. The processing unit 111 may control the constituent elements 113, 115, and 117. The processing unit 111 may operate protocols for communication with an upper server such as gateway, mobility management entity (MME), and the like.

The communication unit 113 may communicate with an external device. The communication unit 113 may communicate with the UE through a wireless channel. The communication unit 113 can communicate with other stations 120 and 130 through a interface between stations such as an X2 interface in LTE.

The handover control database 115 may store and manage a history of handovers previously executed by the station 110. The handover control database 115 may store information of a plurality of handover cases of a plurality of user equipments. The handover control database 115 may store and manage a history of handovers such as a successful handover, a too early handover, a too late handover, a handover to a wrong cell, or the like.

The handover parameter database 117 may store and manage various parameters needed for the station 110 to manage the handover control database 115. The handover parameter database 117 may store and manage a reference used to judge types of handover histories (e.g., a successful handover, a too early handover, a too late handover, a handover to a wrong cell, etc.), a reference used to judge whether or not to refer to handover control database 115 upon a handover of the UE, and the like.

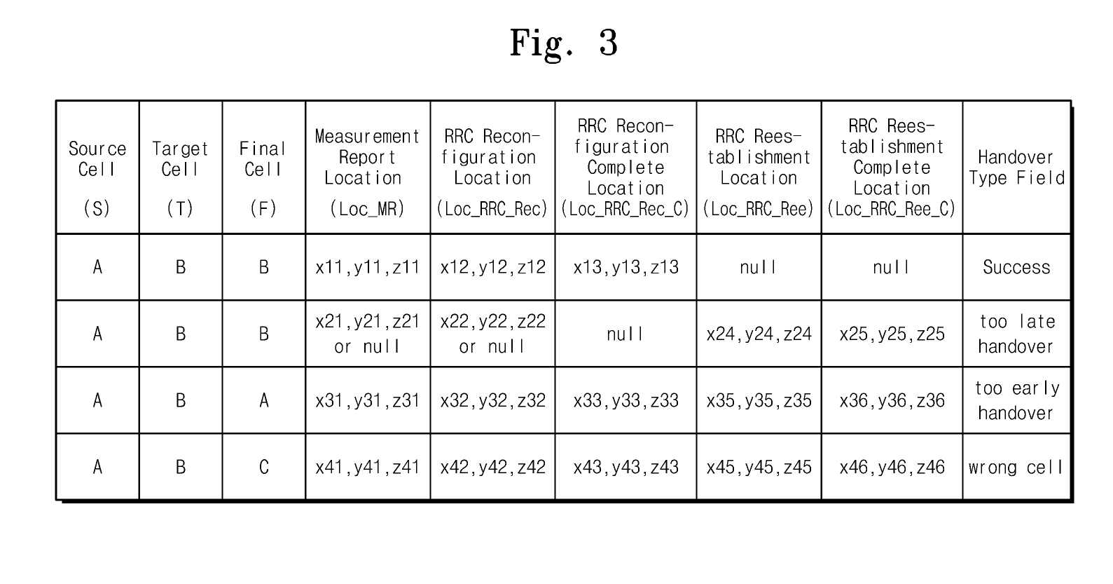

FIG. 3 is a table illustrating handover histories stored at and managed by a handover control database in FIG. 2. Referring to FIG. 3, handover histories may include information corresponding to a plurality of fields (hereinafter, referred to as handover history fields). The handover history fields may include a source cell field S, a target cell field T, a final cell field F, a measurement report location field Loc_MR, an RRC reconfiguration location field Loc_RRC_Rec, an RRC reconfiguration complete location field Loc_RRC_Rec_C, an RRC reestablishment location field Loc_RRC_Ree, an RRC reestablishment complete location field Loc_RRC_Ree_C, and a handover type field.

Handover histories may be stored and managed using records. One handover history may be stored and managed using one handover record. One handover record may include information corresponding to handover history fields.

The source cell field S may indicate a source cell communicating with the UE before a handover. Handover records may include identifiers of source cells as elements of the source cell field S.

The target cell field T may indicate a target cell determined as a handover target when a handover is performed. Handover records may include identifiers of target cells as elements of the target cell field T.

The final cell field F may indicate a cell communicating the UE after a handover is performed. Handover records may include identifiers of final cells as elements of the final cell field F.

The measurement report location field Loc_MR may indicate a location where the UE transmits measurement report to request a handover.

The RRC reconfiguration location field Loc_RRC_Rec may indicate a location where the UE receives a Radio Resource Control (RRC) connection reconfiguration message being a message informing a start of a handover from a source cell after the UE sends the measurement report MR.

The RRC reconfiguration complete location field Loc_RRC_Rec_C may indicate a location where the UE sends an RRC connection reconfiguration complete message being a message informing that a handover to a target cell is completed to a target cell.

The RRC reestablishment location field Loc_RRC_Ree may indicate a location where the UE sends an RRC connection reestablishment message being a message for retrying connection after experiencing radio link failure RLF during a handover to a target cell.

The RRC reestablishment complete location field Loc_RRC_Ree_C may indicate a location where the UE completes connection after sending the RRC connection reestablishment message.

Location information corresponding to the source cell field S, the target cell field T, the final cell field F, the measurement report location field Loc_MR, the RRC reconfiguration location field Loc_RRC_Rec, the RRC reconfiguration complete location field Loc_RRC_Rec_C, the RRC reestablishment location field Loc_RRC_Ree, and the RRC reestablishment complete location field Loc_RRC_Ree_C may be collected by the UE. The UE may collect the location information using a location detecting device such as GPS. The UE may collect the location information from a station. The source cell field S, the target cell field T, the final cell field F, the measurement report location field Loc_MR, the RRC reconfiguration location field Loc_RRC_Rec, the RRC reconfiguration complete location field Loc_RRC_Rec_C, the RRC reestablishment location field Loc_RRC_Ree, and the RRC reestablishment complete location field Loc_RRC_Ree_C may be reported to the station through the UE.

Information sent from the UE may be stored and managed at a station corresponding to a source cell identifier of the source cell field S. The station may judge a handover type (e.g., a successful handover, a too early handover, a too late handover, a handover to a wrong cell, etc.) based on the source cell field S, the target cell field T, the final cell field F, the measurement report location field Loc_MR, the RRC reconfiguration location field Loc_RRC_Rec, the RRC reconfiguration complete location field Loc_RRC_Rec_C, the RRC reestablishment location field Loc_RRC_Ree, and the RRC reestablishment complete location field Loc_RRC_Ree_C, and may store the input information and a judgment result at a handover record.

A first handover record may correspond to a successful handover. That is, the first handover record may include location movement information of the UE associated with the successful handover.

A second handover record may correspond to a too late handover. That is, the second handover record may include location movement information of the UE associated with the too late handover.

A third handover record may correspond to a too early handover. That is, the third handover record may include location movement information of the UE associated with the too early handover.

A fourth handover record may correspond to a handover to a wrong cell. That is, the fourth handover record may include location movement information of the UE associated with the handover to the wrong cell.

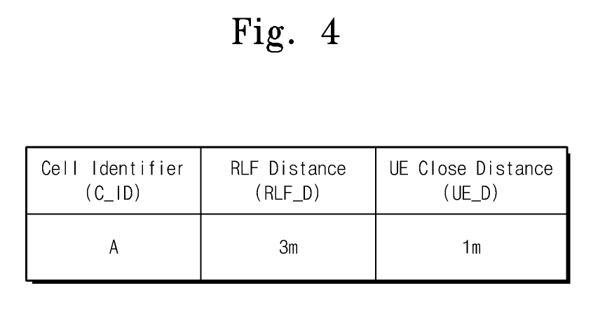

FIG. 4 is a table illustrating handover parameters stored and managed at a handover parameter database in FIG. 2. Referring to FIG. 4, a handover parameter may include a cell identifier field C_ID, an RLF distance field RLF_D, and an UE close distance field UE_D.

The cell identifier field C_ID may indicate an identifier of a source cell to which the RLF distance field RLF_D and the UE close distance field UE_D are applied.

The RLF distance field RLF_D may indicate for judging a too early handover or a too late handover following a normal handover when RLF is generated at a handover. Also, the RLF distance field RLF_D may indicate for judging a handover to a wrong cell or a too late handover following a normal handover when RLF is generated at a handover.

The UE close distance field UE_D may indicate a parameter for judging whether or not to perform a handover of the UE referring to a handover history database 115 when the UE wants to hand over.

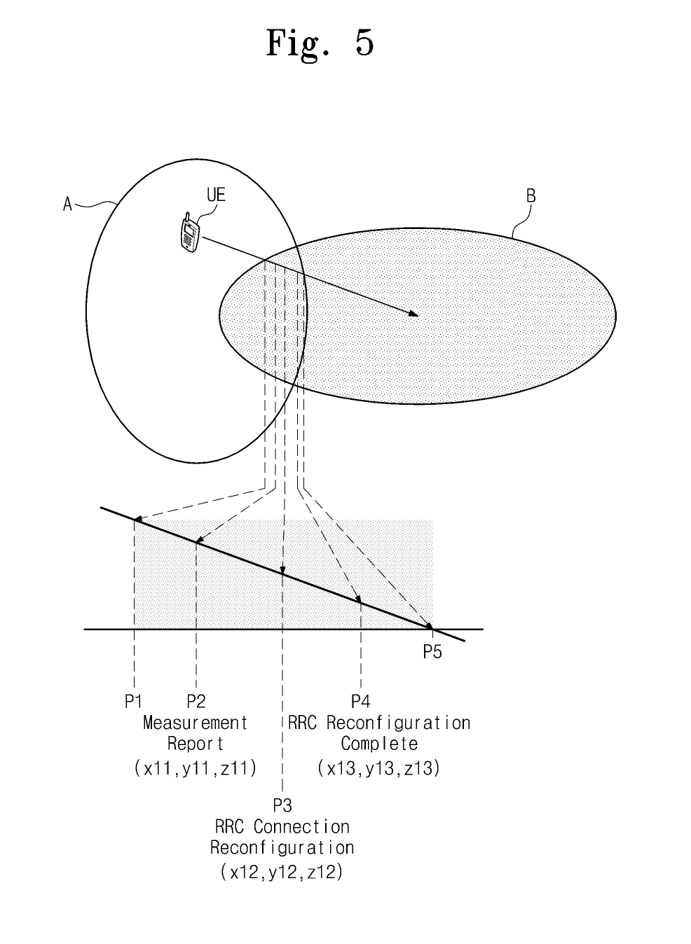

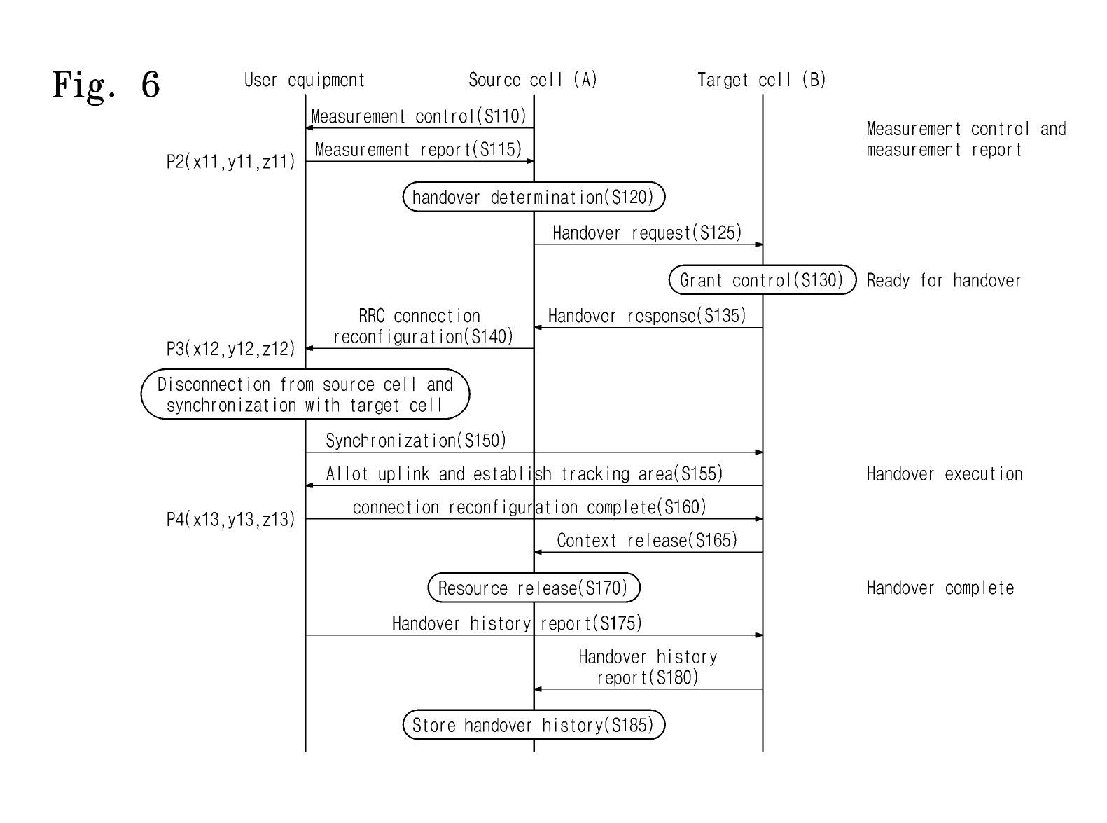

FIG. 5 is a diagram illustrating a location movement of the UE when the UE performs a successful handover from a source cell to a target cell. FIG. 6 is a diagram illustrating a procedure when the UE performs a successful handover from a source cell to a target cell.

Referring to FIGS. 3, 5, and 6, the UE may move from a first point P1 to a fifth point P5. That is, a handover may be performed while the UE moves from a source cell A to a target cell B.

In operation S110, a source station A may send a measurement control message to the UE. The source station A may periodically send the measurement control message to the UE. In operation S115, the UE may send a measurement report message to the source station A in response to the measurement control message. In example embodiments, after moving from the first point P1 to a second point P2, the UE may send the measurement report message to the source station A at the second point P2. At this time, the UE may store coordinates (x11, y11, z11) corresponding to the second point P2 from which the measurement report message is sent.

The UE may send the coordinates (x11, y11, z11) of the second point P2, from which the measurement report message is sent, to the source station A together with the measurement report message.

In operation S120, the source station A may determine a handover of the UE in response to the measurement report message. When the handover of the UE is determined by the source station A, in operation S125, the source station A may send a handover request message to a target station B.

In operation S130, the target station B may make admission control in response to the handover request message. In operation S135, the target station B may send a handover acknowledge message to the source station A.

When the handover acknowledge message is received, in operation S140, the source station A may send an RRC connection reconfiguration message to the UE. At this time, the UE may arrive at a third point P3 from the second point P2. The UE may store coordinates (x12, y12, z12) of the third point P3 where the RRC connection reconfiguration message is received.

In operation S145, the UE may be separated from the source cell, and may process synchronization with the target cell. In operation S150, the UE may send a synchronization message to the target cell B. In operation S155, the target station B may send a message for setting uplink allocation and a tracking area of the UE to the UE.

In operation S160, the UE may send an RRC connection reconfiguration complete message to the target station B. For example, when the UE is located at a fourth point P4, the RRC connection reconfiguration complete message may be sent. The UE may store coordinates (x13, y13, z13) of the fourth point P4 where the RRC connection reconfiguration complete message is sent.

In operation S165, the target station B may send a context release message to the source station A. In operation S170, the source station A may release a resource allotted to the UE.

After the handover is completed, in operation S175, the UE may report a handover history. Since the UE communicates with the target station B, the UE may send the handover history to the target station B. The UE may provide the target station B with information corresponding to a source cell field S, a target cell field T, a final cell field F, a measurement report location field Loc_MR, an RRC reconfiguration location field Loc_RRC_Rec, an RRC reconfiguration complete location field Loc_RRC_Rec_C, an RRC reestablishment location field Loc_RRC_Ree, and an RRC reestablishment complete location field Loc_RRC_Ree_C.

The source cell field S of the handover history sent from the UE may indicate the source station A. Thus, in operation S180, the target station B may again send the input handover history to the source station A.

In operation S185, the source station A may store the input handover history. The source station A may judge whether the executed handover is a successful handover, a too early handover, a too late handover, or a handover to a wrong cell, based on the handover history. Since the handover is completed as the UE does not experience RLF, the source station A may judge to be a successful handover, and may store the judgment result at a handover record together with the input handover history.

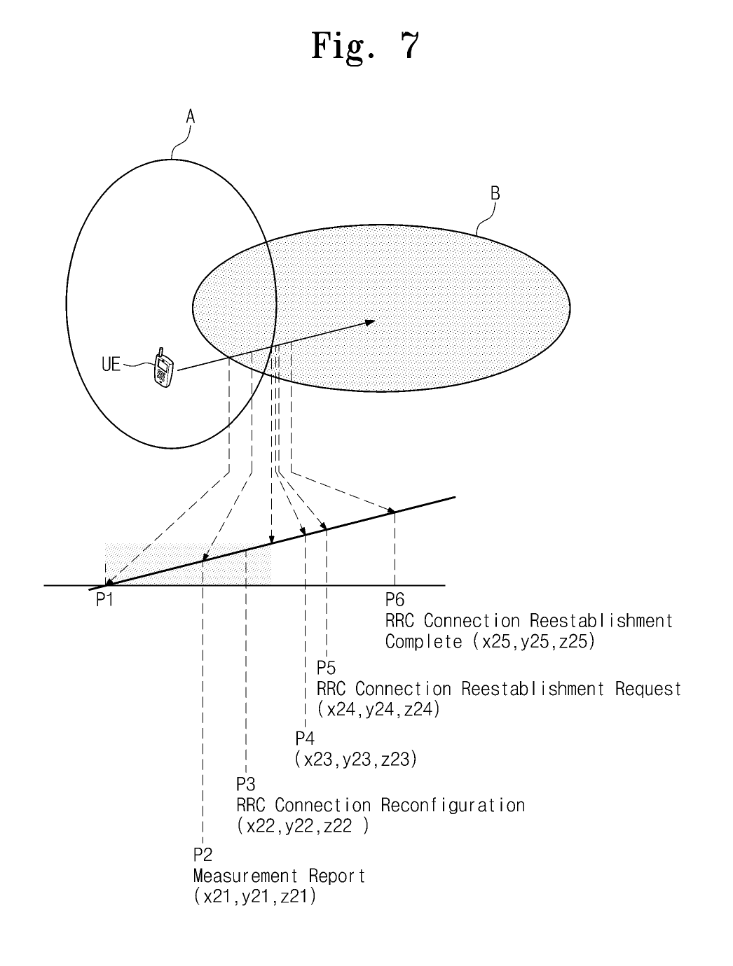

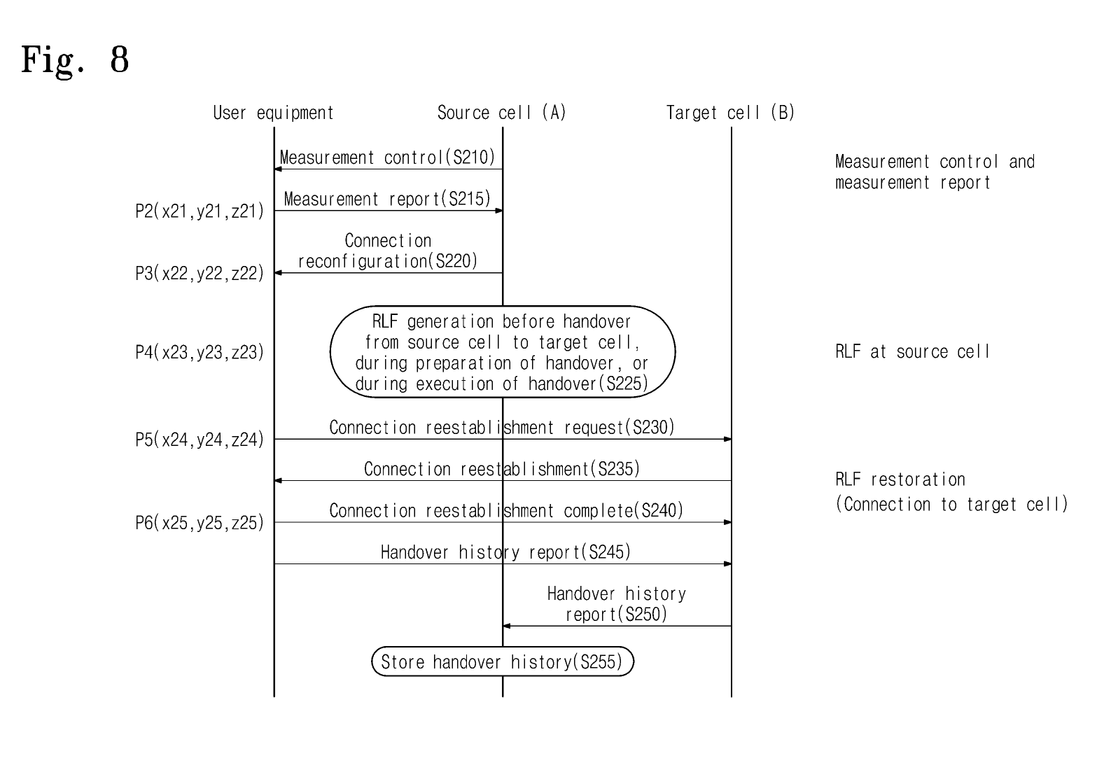

FIG. 7 is a diagram illustrating a location movement of the UE when the UE performs a too late handover from a source cell to a target cell. FIG. 8 is a diagram illustrating a procedure when the UE performs a too late handover from a source cell to a target cell. In FIGS. 7 and 8, duplicative procedures may be omitted.

Referring to FIGS. 3, 7, and 8, the UE may move from a first point P1 to a sixth point P6. That is, a handover may be performed while the UE moves from a source cell A to a target cell B.

In operation S210, a source station A may send a measurement control message to the UE. The source station A may periodically send the measurement control message to the UE. In operation S215, the UE may send a measurement report message to the source station A in response to the measurement control message. In example embodiments, after moving from the first point P1 to a second point P2, the UE may send the measurement report message to the source station A at the second point P2. At this time, the UE may store coordinates (x21, y21, z21) corresponding to the second point P2 from which the measurement report message is sent.

The UE may send the coordinates (x21, y21, z21) of the second point P2, from which the measurement report message is sent, to the source station A together with the measurement report message.

In operation S220, the source station A may send an RRC connection reconfiguration message to the UE. At this time, the UE may arrive at a third point P3 from the second point P2. The UE may store coordinates (x22, y22, z22) of the third point P3 where the RRC connection reconfiguration message is received.

In operation S225, the UE may experience RLF before a handover from the source cell A to a target cell B, during preparation of a handover, or during execution of a handover. That is, the UE may experience RLF before sending an RRC connection reconfiguration complete message. For example, the UE may experience RLF at a fourth point P4 where the UE gets out of coverage of the source cell before a handover is completed.

In operation S230, the UE may send an RRC connection reestablishment request message. For example, the UE may send the RRC connection reestablishment request message to a cell having the strongest signal from among peripheral cells. In case of a too late handover, the UE may be closest to the target cell B and receive the strongest signal from the target cell B. That is, the UE may send an RRC connection reestablishment request message. At this time, the UE may store coordinates (x24, y24, z24) of a fifth point P5 from which the RRC connection reestablishment request message is sent.

In operation S235, the target station B may send the RRC connection reestablishment request message to the UE.

In operation S240, the UE may send an RRC connection reconfiguration complete message to the target station B. At this time, the UE may store coordinates (x25, y25, z25) of a sixth point P6 where the RRC connection reconfiguration complete message is sent.

After RRC connection is reestablished, in operation S245, the UE may report a handover history. Since the UE communicates with the target station B, the UE may send the handover history to the target station B.

The source cell field S of the handover history sent from the UE may indicate the source station A. Thus, in operation S250, the target station B may again send the input handover history to the source station A.

In operation S250, the source station A may store the input handover history. The source station A may judge whether the executed handover is a successful handover, a too early handover, a too late handover, or a handover to a wrong cell, based on the handover history. In example embodiments, if the UE may experience RLF before a handover, during preparation of a handover, or during execution of a handover and RRC connection with the target station B is reestablished, a corresponding handover history may judge to be a successful handover. The source station A may store the judgment result at a handover record together with the input handover history.

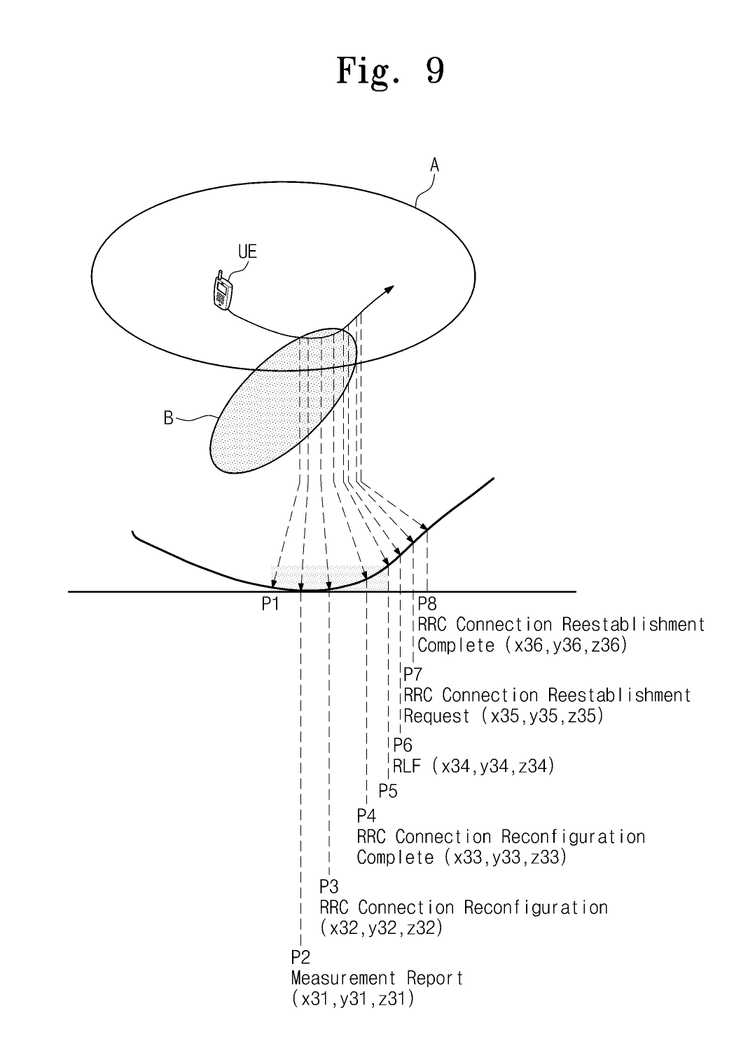

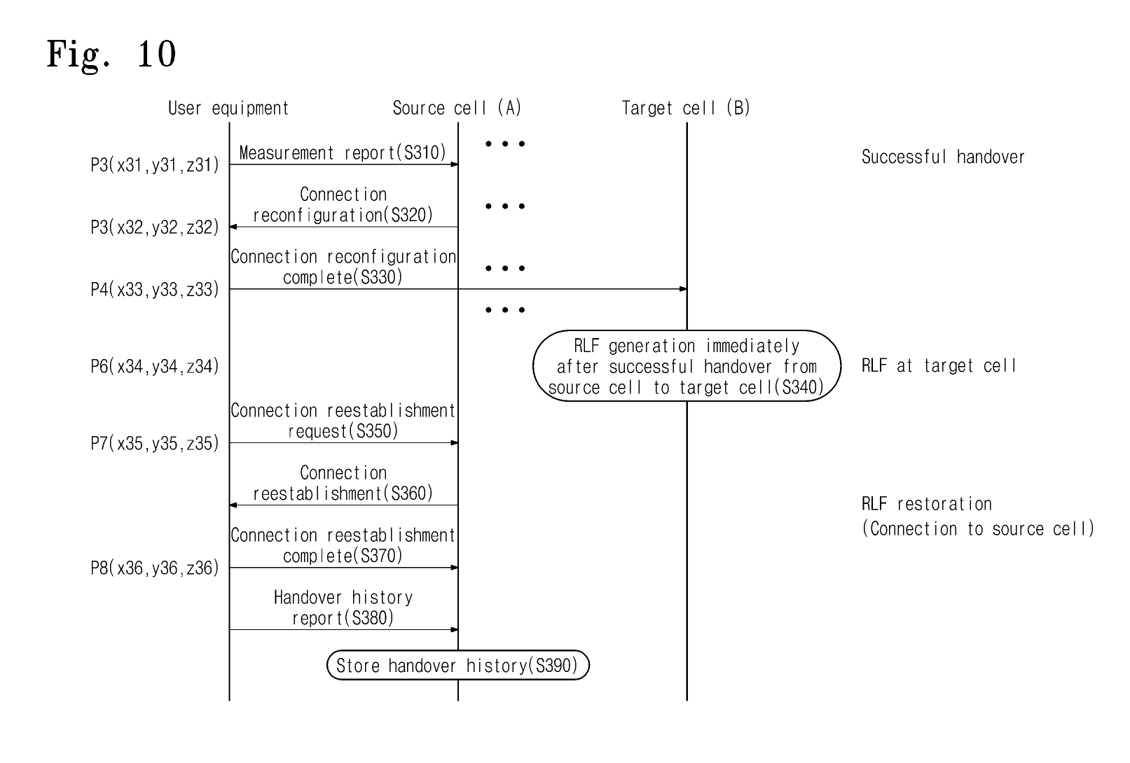

FIG. 9 is a diagram illustrating a location movement of the UE when the UE performs a too early handover from a source cell to a target cell. FIG. 10 is a diagram illustrating a procedure when the UE performs a too early handover from a source cell to a target cell. In FIGS. 9 and 10, duplicative procedures may be omitted.

Referring to FIGS. 3, 9, and 10, the UE may move from a first point P1 to an eight point P8. That is, a handover may be performed while the UE moves from a source cell A to a target cell B.

In operation S310, a source station A may send a measurement report message to the UE. At this time, the UE may store coordinates (x31, y31, z31) corresponding to a second point P2 from which the measurement report message is sent.

The UE may send the coordinates (x31, y31, z31) of the second point P2, from which the measurement report message is sent, to the source station A together with the measurement report message.

In operation S320, the source station A may send an RRC connection reconfiguration message to the UE. At this time, the UE may arrive at a third point P3 from the second point P2. The UE may store coordinates (x32, y32, z32) of a third point P3 where the RRC connection reconfiguration message is received.

In operation S330, the UE may send an RRC connection reconfiguration complete message to a target station B. At this time, the UE may store coordinates (x33, y33, z33) of a fourth point P4 where the RRC connection reconfiguration complete message is sent.

In operation S340, the UE may experience RLF immediately after the UE completes a handover from the source cell A to the target cell B. For example, the UE may experience RLF at a sixth point P6 where the UE comes back to the source cell A.

In operation S350, the UE may send an RRC connection reestablishment request message. For example, the UE may send the RRC connection reestablishment request message to a cell having the strongest signal from among peripheral cells. In case of a too early handover, the UE may be closest to the source cell A, and may receive the strongest signal from the source cell A. That is, the UE may send the RRC connection reestablishment request message to the source cell A. At this time, the UE may store coordinates (x35, y35, z35) of a seventh point P7 from which the RRC connection reestablishment request message is sent.

In operation 360, the source station A may send an RRC connection reestablishment message to the UE.

In operation S370, the UE may send an RRC connection reestablishment complete message to the source station A. At this time, the UE may store coordinates (x36, y36, z36) of an eighth point P8 from which the RRC connection reestablishment complete message is sent.

After RRC connection is reestablished, in operation S380, the UE may report a handover history. Since the UE communicates with the source station A, the UE may send the handover history to the source station A.

The source cell field S of the handover history sent from the UE may indicate the source station A. Thus, in operation S390, the source station A may store the input handover history. The source station A may judge whether the executed handover is a successful handover, a too early handover, a too late handover, or a handover to a wrong cell, based on the handover history. In example embodiments, if the UE may experience RLF immediately after a successful handover and RRC connection is reestablished with the source station A, not the target station B or another station, a corresponding handover history may judge to be a too early handover.

In example embodiments, whether the UE experiences RLF immediately after a successful handover may be judged according to a difference between coordinates (x33, y33, z33) of a fourth point P4, from which the RRC connection reconfiguration message is sent, and coordinates (x35, y35, z35) of a seventh point P7, from which the RRC connection reestablishment request message is sent.

When a difference between the coordinates (x33, y33, z33) of the fourth point P4 and the coordinates (x35, y35, z35) of the seventh point P7 is less than a value (e.g., 3 m) an RLF distance field RLF_D defined at a handover parameter database 117 (refer to FIG. 4), it may indicate that RLF is generated immediately after the successful handover, that is, that a too early handover is generated. The source station A may store this information at a handover record together with the input handover history.

When a difference between the coordinates (x33, y33, z33) of the fourth point P4 and the coordinates (x35, y35, z35) of the seventh point P7 is equal to or more than a value (e.g., 3 m) an RLF distance field RLF_D defined at the handover parameter database 117, an executed handover may be judged not to be a too early handover. For example, the executed handover may be judged to be a handover where the UE moves to the target cell B through a successful handover and then again returns to the source cell A through a too later handover. The source station A may store a corresponding handover record as further information or discard it.

In example embodiments, in case of a successful handover, the UE may complete RRC connection reconfiguration with the target cell B to then report a handover history to the target cell B. The source station A may receive and store a handover history, which the UE sends to the target cell B, from the target cell B. Afterwards, the UE may experience RLF as it enters the source cell A. The UE may reestablish RRC connection with the source cell A, and may report a handover history to the source cell A. That is, in connection with the same handover, the source cell A may further receive a too early handover history with a successful handover history stored.

When a too early handover history is received, the source cell A may search a handover control database 115 to judge whether the same handover history is stored. When the same handover history is as a successfully handover, the source cell A may delete a corresponding handover history to again store a too early handover history.

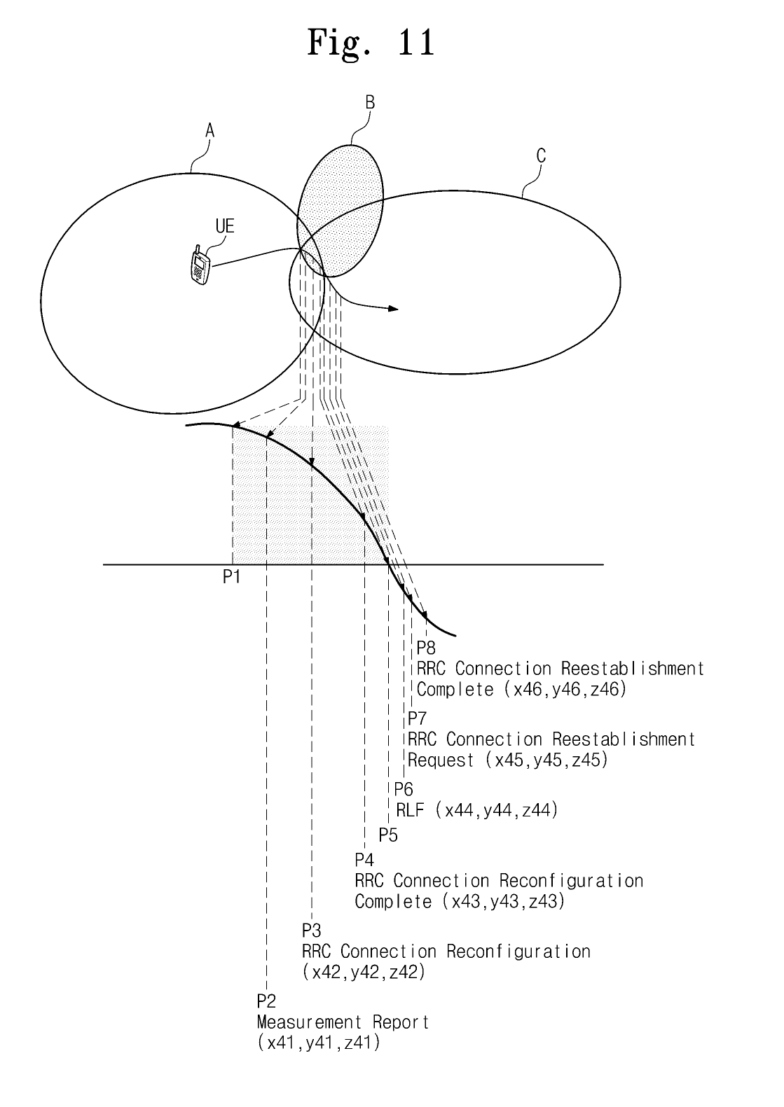

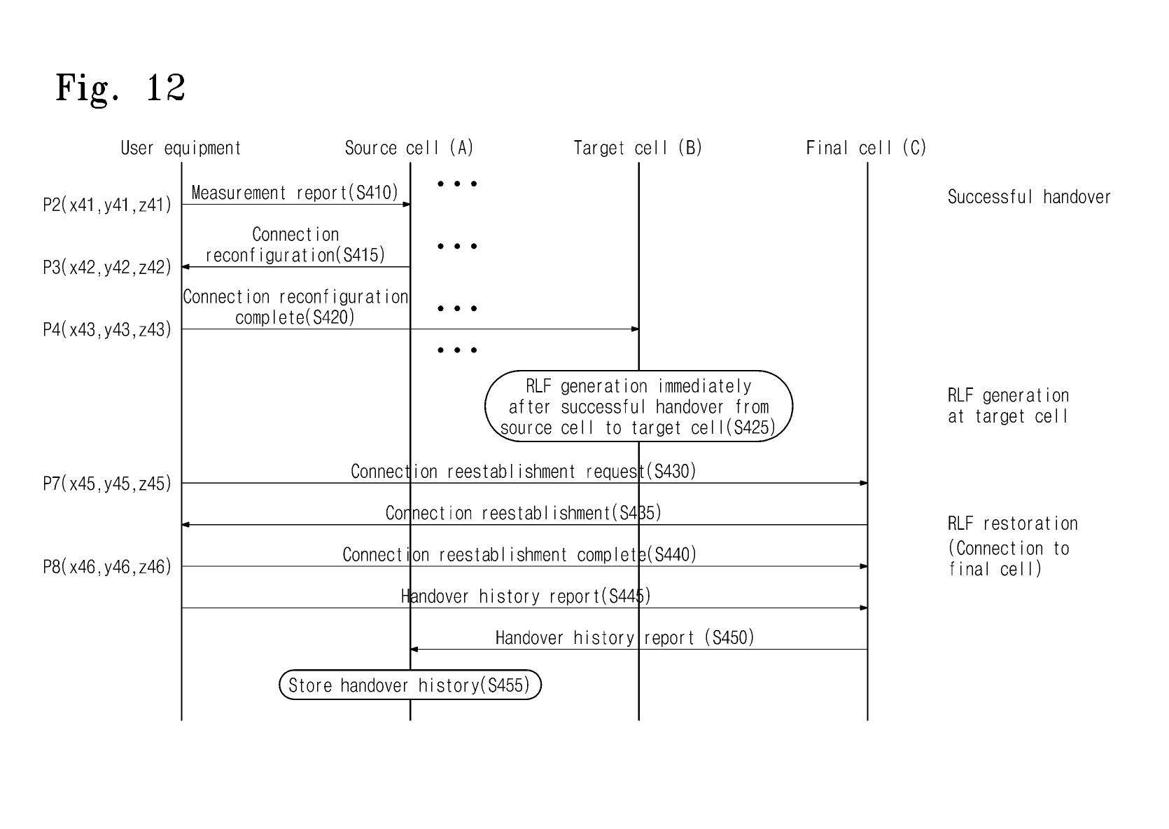

FIG. 11 is a diagram illustrating a location movement of the UE when the UE performs a handover to a wrong cell. FIG. 12 is a diagram illustrating a procedure when the UE performs a handover to a wrong cell. In FIGS. 11 and 12, duplicative procedures may be omitted.

Referring to FIGS. 3, 11, and 12, the UE may move from a first point P1 to an eight point P8. That is, a handover may be performed while the UE moves from a source cell A to a final cell C.

In operation S410, a source station A may send a measurement report message to the UE. At this time, the UE may store coordinates (x41, y41, z41) corresponding to a second point P2 from which the measurement report message is sent.

In operation S415, the source station A may send an RRC connection reconfiguration message to the UE. At this time, the UE may arrive at a third point P3 from the second point P2. The UE may store coordinates (x42, y42, z42) of a third point P3 where the RRC connection reconfiguration message is received.

In operation S420, the UE may send an RRC connection reconfiguration complete message to a target station B. At this time, the UE may store coordinates (x43, y43, z43) of a fourth point P4 where the RRC connection reconfiguration complete message is sent.

In operation S425, the UE may experience RLF immediately after the UE completes a handover from the source cell A to the target cell B. For example, the UE may experience RLF at a sixth point P6 where the UE enters a final cell C.

In operation S430, the UE may send an RRC connection reestablishment request message. For example, the UE may send the RRC connection reestablishment request message to a cell having the strongest signal from among peripheral cells. In case of a handover to a wrong cell, the UE may be closest to the final cell B, and may receive the strongest signal from the final cell C. That is, the UE may send the RRC connection reestablishment request message to the final cell C. At this time, the UE may store coordinates (x45, y45, z45) of a seventh point P7 from which the RRC connection reestablishment request message is sent.

In operation 435, a final station C may send an RRC connection reestablishment message to the UE.

In operation S440, the UE may send an RRC connection reestablishment complete message to the target station C. At this time, the UE may store coordinates (x46, y46, z46) of an eighth point P8 from which the RRC connection reestablishment complete message is sent.

After RRC connection is reestablished, in operation S445, the UE may report a handover history. Since the UE communicates with the final station C, the UE may send the handover history to the final station C.

The source cell field S of the handover history sent from the UE may indicate the source station A. Thus, in operation S490, the final station C may send the input handover history to the source station A. In operation S455, the source station A may judge whether the executed handover is a successful handover, a too early handover, a too late handover, or a handover to a wrong cell, based on the handover history. In example embodiments, if the UE may experience RLF immediately after a successful handover and RRC connection is reestablished with the final station C, not the source station A or the target station B, a corresponding handover history may judge to be a handover to a wrong cell.

In example embodiments, whether the UE experiences RLF immediately after a successful handover may be judged according to a difference between coordinates (x43, y43, z43) of a fourth point P4, from which the RRC connection reconfiguration message is sent, and coordinates (x45, y45, z45) of a seventh point P7, from which the RRC connection reestablishment request message is sent.

When a difference between the coordinates (x43, y43, z43) of the fourth point P4 and the coordinates (x45, y45, z45) of the seventh point P7 is less than a value (e.g., 3 m) an RLF distance field RLF_D defined at a handover parameter database 117 (refer to FIG. 4), it may indicate that RLF is generated immediately after the successful handover, that is, that a handover to a wrong cell is generated. The source station A may store this information at a handover record together with the input handover history.

When a difference between the coordinates (x43, y43, z43) of the fourth point P4 and the coordinates (x45, y45, z45) of the seventh point P7 is equal to or more than a value (e.g., 3 m) an RLF distance field RLF_D defined at the handover parameter database 117, an executed handover may be judged not to be a handover to a wrong. For example, the executed handover may be judged to be a handover that the UE moves to the target cell B through a successful handover and then again returns to the final cell C through a too later handover. The source station A may store a corresponding handover record as further information or discard it.

In example embodiments, like a successful handover, the UE may complete RRC connection reconfiguration with the target cell B to then report a handover history to the target cell B. The source station A may receive and store a handover history, which the UE sends to the target cell B, from the target cell B. Afterwards, the UE may experience RLF as it enters the final cell C. The UE may reestablish RRC connection with the final cell C, and may report a handover history to the final cell C. That is, in connection with the same handover, the final cell C may further receive a too early handover history with a successful handover history stored.

When a handover history associated with a handover to a wrong cell is received, the source cell A may search a handover control database 115 to judge whether the same handover history is stored. When the same handover history is as a successfully handover, the source cell A may delete a corresponding handover history to again store a handover history associated with a handover to a wrong cell.

As described above, a station according to an embodiment of the inventive concept may receive a handover history including location information from the UE to control a handover of the UE.

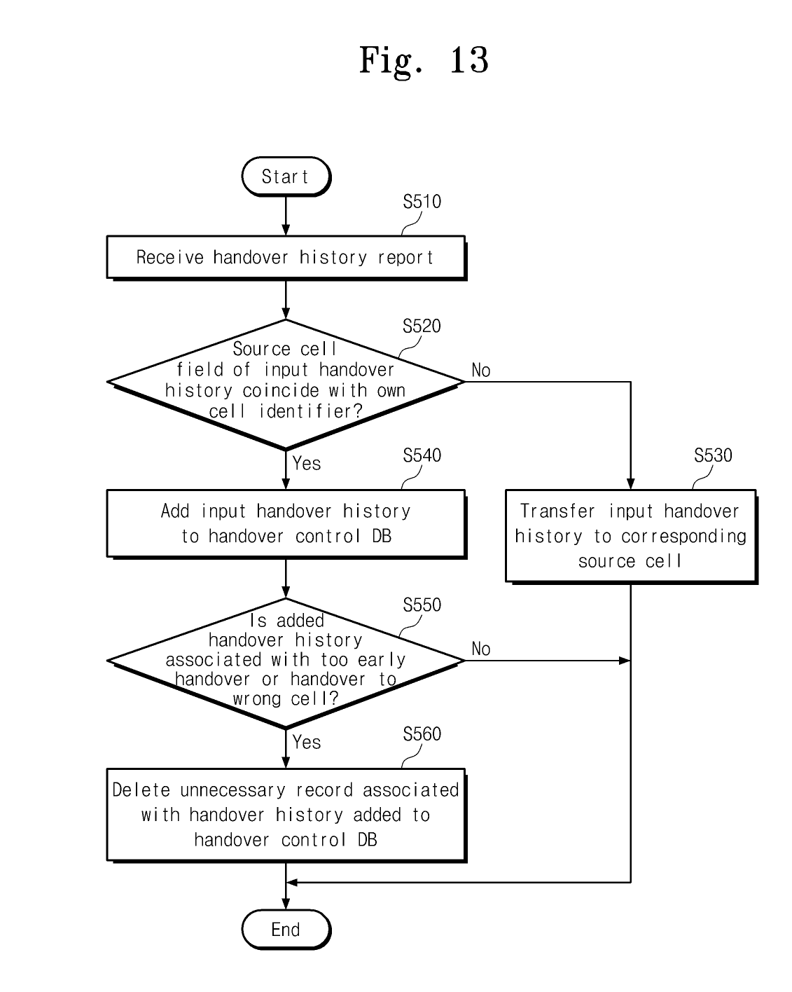

FIG. 13 is a flowchart illustrating a method of storing a handover history at a handover control database through a station. Referring to FIG. 13, in operation S510, a station 110 may receive a handover history report from the UE or another station 120 or 130.

In operation S520, the station 110 may judge whether a source cell field S of the input handover history coincides with own cell identifier. If not, in operation S530, the station 110 may forward the input handover history to a corresponding source cell. If so, in operation S540, the station 110 may add the input handover history to a handover control database 115.

In operation S550, the station 110 may judge whether the added handover history is associated with a too early handover or a handover to a wrong cell. If the added handover history is not associated with a too early handover or a handover to a wrong cell, the method may be ended.

If the added handover history is associated with a too early handover or a handover to a wrong cell, in operation S560, the station 110 may delete an unnecessary record associated with a handover history added to the handover control database 115. For example, the station 110 may search a history from among handover histories previously stored at the handover control database 115, having a source cell field S, a target cell field T, a measurement report location field Loc_MR, an RRC reconfiguration location field Loc_RRC_Rec, and an RRC reconfiguration complete location field Loc_RRC_Rec_C of the searched history being identical to those of the added handover history. There may be selected such a history that an RRC reestablishment location field Loc_RRC_Ree and an RRC reestablishment complete location field Loc_RRC_Ree_C are null, that is, a successful handover history, from the selected histories. The selected handover history may be judged to be a successful handover history reported at the same handover as the added handover history, before experience of RLF, and immediately after a successful handover. The station 110 may delete the selected handover history. That is, a handover history associated with a too early handover or a handover to a wrong cell may be stored at the handover control database 115 instead of a duplicative successful handover history.

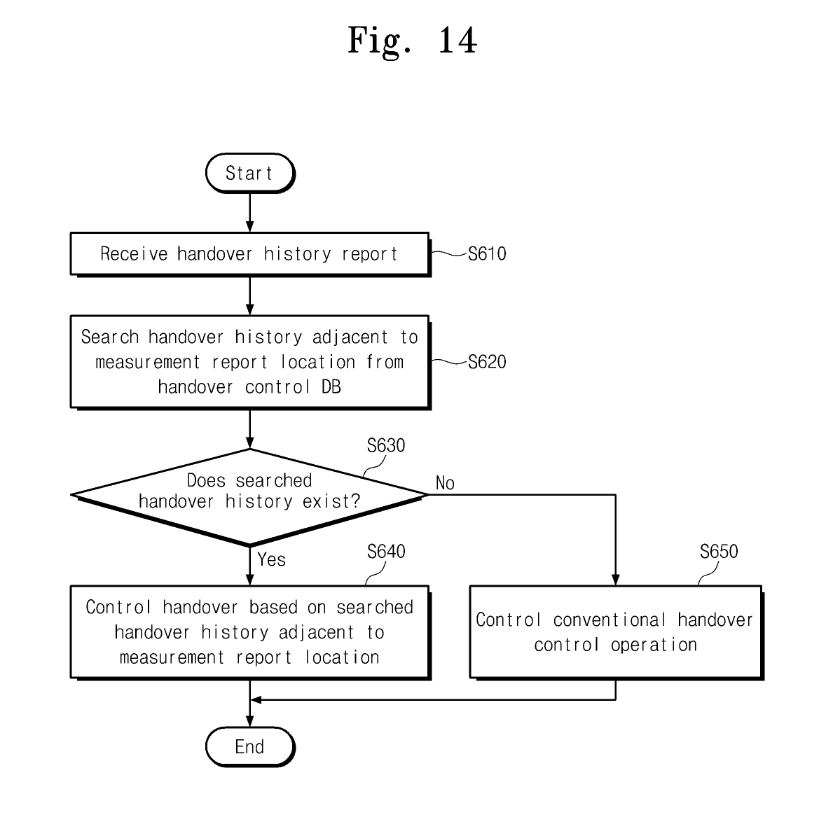

FIG. 14 is a flowchart illustrating a method of controlling a handover of the UE according to a handover history. Referring to FIGS. 2 and 14, in operation S610, a station 110 may receive a measurement report message from the UE. The UE may send coordinates of a location, from which the measurement report message is sent, together with the measurement report message. Thus, the station 110 may acquire the coordinates of a location from which the UE sends the measurement report message.

In operation S620, the station 110 may search a handover history adjacent to a measurement report location from a handover control database 115. The station 110 may search a handover history of a plurality of handovers of a plurality of user equipments. For example, the station 110 may search a handover history based on an UE close distance field UE_D of a handover parameter database 117.

For example, there may be searched handover histories where a difference between the measurement report location and measurement report locations of handover histories of the handover control database 115 is less than a value (e.g., 1 m) of the UE close distance field UE_D. There may be ignored handover histories where a difference between the measurement report location and measurement report locations of handover histories of the handover control database 115 is equal to or more than the value (e.g., 1 m) of the UE close distance field UE_D.

In operation S630, the station 110 may judge whether a searched handover history exists. If so, the station 110 may control a handover based on the searched handover history, that is, a handover history adjacent to the measurement report location. If not, in operation S650, the station 110 may control a conventional handover control operation.

For example, when the searched handover history is a successful handover, the station 110 may control the UE to be handed over to the same target station according to the same timing as the searched handover history.

If the searched handover history is a too late handover, the station 110 may control the UE to be handed over to the same target station according to a faster timing as the searched handover history.

In the case that the searched handover history is a too early handover, the station 110 may control the UE not to be handed over to the same target station as the searched handover history.

If the searched handover history is a handover to a wrong cell, the station 110 may control the UE to be handed over to a final station, not to be handed over to a target station of the searched handover history.

With the inventive concept, a wireless communication terminal may store location information at a handover and report a handover history including the location information to a station. The station may control a handover of the wireless communication terminal using the handover history.

While the inventive concept has been described with reference to exemplary embodiments, it will be apparent to those skilled in the art that various changes and modifications may be made without departing from the spirit and scope of the present invention. Therefore, it should be understood that the above embodiments are not limiting, but illustrative.

What is claimed is:

1. A handover controlling method in which a station controls a handover of a user equipment, comprising:
receiving a handover request including location information from the user equipment; and
comparing the location information with handover histories previously executed at the station to control a handover of the user equipment according to a comparison result.

2. The handover controlling method of claim 1, wherein the comparing the location information with handover histories previously executed at the station to control a handover of the user equipment according to a comparison result comprises:
controlling a handover of the user equipment according to a handover history, executed within a reference distance from a location corresponding to the location information, among from the previously executed handover histories.

3. The handover controlling method of claim 2, wherein the controlling a handover of the user equipment according to a handover history comprises:
controlling a handover of the user equipment the same as the handover history being a successful handover.

4. The handover controlling method of claim 2, wherein the controlling a handover of the user equipment according to a handover history comprises:
terminating a handover of the user equipment when the handover history is a too early handover.

5. The handover controlling method of claim 2, wherein the controlling a handover of the user equipment according to a handover history comprises:
controlling a handover of the user equipment to be faster than the handover history when the handover history is a too late handover.

6. The handover controlling method of claim 2, wherein the controlling a handover of the user equipment according to a handover history comprises:
controlling a handover of the user equipment to a final cell indicated by the handover history when the handover history is a handover to a wrong cell.

7. The handover controlling method of claim 1, further comprising:
receiving a handover history report from the user equipment;
judging whether the handover history is a successful handover, a too early handover, a too late handover, or a handover to a wrong cell; and
storing the judgment result with the handover history.

8. The handover controlling method of claim 7, wherein the handover history is judged to be the successful handover when the handover history indicates a handover executed without radio link failure.

9. The handover controlling method of claim 7, wherein the handover history is judged to be the too late handover when the handover history indicates that radio link failure is generated before completion of a handover and then radio resource control connection are reestablished with a target station.

10. The handover controlling method of claim 7, wherein the handover history is judged to be the too early handover when the handover history indicates that radio link failure is generated when a handover is completed and the user equipment moves below a reference distance and then radio resource control connection are reestablished with a source station.

11. The handover controlling method of claim 7, wherein the handover history is judged to be the handover to a wrong cell when the handover history indicates that radio link failure is generated when a handover is completed and the user equipment moves below a reference distance and then radio resource control connection are reestablished with a final station not a source station or a target station.

12. The handover controlling method of claim 7, wherein the storing the judgment result with the handover history comprises:
searching a handover history, indicating a successful handover, from among previously stored handover histories when the handover history is the too early handover or the handover to a wrong cell, the searched handover history having the same source cell, target cell, measurement report location, radio resource control reconfiguration location, and radio resource control reconfiguration complete location as the handover history; and
deleting the searched handover history.

13. An operating method of a wireless communication terminal comprising:
storing location information of the wireless communication terminal when sending a handover request;
storing location information of the wireless communication terminal when a handover corresponding to the handover request is completed;
when radio link failure is generated before the handover, during execution of the handover, or after completion of the handover, sending a radio resource control connection reestablishment request and storing location information of the wireless communication terminal; and
sending the stored location information.

14. The operating method of claim 13, wherein the handover request is sent with the location information.

15. The operating method of claim 13, further comprising:
storing location information of the wireless communication terminal when the handover commences.

16. The operating method of claim 13, further comprising:
storing location information of the wireless communication terminal when radio resource control reestablishment is completed.

17. The operating method of claim 13, further comprising:
storing information associated with a communicating cell before the handover, a target cell of the handover when the handover commences, and a finally communicating cell after the handover or the radio link failure.

18. The operating method of claim 17, wherein the information on the stored cells and the stored location information are sent to the finally communicating cell.

19. A station comprising:
a communication unit performing wireless communication with a wireless communication terminal;
a handover control database storing handover histories previously executed within a charging cell; and
a processing unit operating a protocol communicating an upper server and controlling a handover of the wireless communication terminal based on the handover histories stored at the handover control database.

20. The station of claim 19, wherein the handover control database stores the handover histories classified into a successful handover, a too later handover, a too early handover, and a handover to a wrong cell.
